(19) United States
(12) Patent Application Publication
(10) Pub. No.: US 2014/0347702 A1
(43) Pub. Date: Nov. 27, 2014

(54) METHOD FOR PRINTING OBJECT DATA AND PRINTING APPARATUS USING SUCH METHOD

(71) Applicant: Avision Inc., Hsinchu (TW)

(72) Inventor: CHUN-CHIEH LIAO, HSINCHU (TW)

(73) Assignee: AVISION INC., HSINCHU (TW)

(21) Appl. No.: 14/252,768

(22) Filed: Apr. 14, 2014

(30) Foreign Application Priority Data
May 22, 2013 (TW) 102118128

(51) Int. Cl. H04N 1/23; H04N 1/387

(52) U.S. Cl. CPC H04N 1/2384; H04N 1/3877
USPC 358/401

(57) ABSTRACT

A method for printing object is provided. The method includes the following steps: directing a processing unit to identify an object within an initial document; based on the object, directing a printing apparatus to select a recording medium; and directing the printing apparatus to print data of the object on the recording medium. In addition, a printing apparatus using such method is also provided.

### CROSS-REFERENCE TO RELATED APPLICATION

This application claims the benefit of Taiwan Patent Application No. 102118128, filed on May 22, 2013, in the Taiwan Intellectual Property Office, the disclosure of which is incorporated herein in its entirety by reference.

### BACKGROUND OF THE INVENTION

1. Field of the Invention

The present invention is related to a method for printing object data and a printing apparatus using such method, particularly to a method of identifying an object within an initial document and selecting a recording medium based on the object, and a printing apparatus using such method.

2. Description of the Related Art

The copying method combines steps of scanning and printing, the details is described as follows. FIG. 1 is a schematic view of image data and copy generated according to the prior art. In copy operation, the copying machine scans an original sheet first to generate an image data 10. As shown in FIG. 1, image data 10 has an outline border 101. Then, the copying machine judges a page size of image data 10 and prints the image data 10 on a sheet with size equal to or little bigger than said page size. Finally, the copy 20 is generated. In such a case, if image data 10 is in standard size, such as A3 size, the generated copy 20 is also A3 size. However, sometimes user does not need copy of whole area of image data 10. For example, triangle pattern 102 just occupies a part of the whole area, and the other part is blankness image. Therefore, when the copying machine selects a sheet having size the same as the page size of image data 10, it causes not only unnecessary consumption of sheet resource, but also additional sheet cutting work for user to obtain the triangle pattern 201 on the copy 20.

### SUMMARY OF THE INVENTION

Therefore, a primary objective of the present invention is to identify an object within an initial document automatically, and only print the object.

Another objective of the present invention is to select an appropriate recording medium based on attribute of the object, and print the object, so as to simplify operation procedure, and to reduce consumption of recording medium, and to shorten printing time.

To achieve above objective, a method for printing object data is provided. The method comprises following steps of: directing a processing unit to identify an object within an initial document; directing a printing apparatus to select a recording medium based on the object; and directing the printing apparatus to print data of the object on the recording medium.

To achieve above objective, a printing apparatus is also provided. The printing apparatus comprises a sheet feeding device, a processing unit, a control circuit and a printing module. The processing unit is used to process an initial document, and identify an object within the initial document. The control circuit is connected electrically to the processing unit, and controls the sheet feeding device to feed a recording medium based on the object identified by the processing unit. The printing module is connected electrically to the control circuit, and prints data of the object on the fed recording medium.

Concept of the present invention, and many of the attendant advantages thereof, will be readily apparent as the same becomes better understood by reference to the following detailed description when considered in conjunction with the accompanying drawings.

### BRIEF DESCRIPTION OF THE DRAWINGS

The detailed structure, operating principle and effects of the present invention will now be described in more details hereinafter with reference to the accompanying drawings that show various embodiments of the invention as follows.

FIG. 1 is a schematic view of image data and copy generated according to the prior art.

FIG. 2 is a schematic view of the first embodiment of the printing apparatus according to the present invention.

FIG. 3 is schematic view of an initial document of the present invention.

FIG. 4 displays the schematic view of the initial document having picture object shown in FIG. 3.

FIG. 5 is a schematic view of a document sheet printed by the printing apparatus according to the first embodiment of the present invention.

FIG. 6 is a schematic view of the second embodiment of the printing apparatus according to the present invention.

FIG. 7 is a schematic view of a document sheet printed by the printing apparatus according to the second embodiment of the present invention.

FIG. 8 is a flow of the preferred embodiment of method for printing object data according to the present invention.

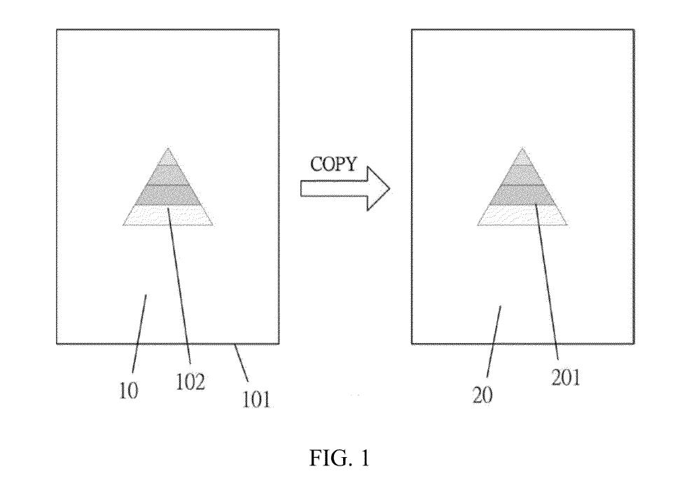

### DETAILED DESCRIPTION OF THE PREFERRED EMBODIMENTS

The technical content of the present invention will become apparent by the detailed description of the following embodiments and the illustration of related drawings as follows. However, the drawings and the embodiments to be described below are just exemplified to describe the present disclosure, and the scope of the present disclosure is not limited to the drawings and the embodiments. It will be understood that when an element or layer is referred to as being “on”, “connected to”, “coupled to”, or “adjacent to” another element or layer, it can be directly on, connected, coupled, or adjacent to the other element or layer, or intervening elements or layers may be present.

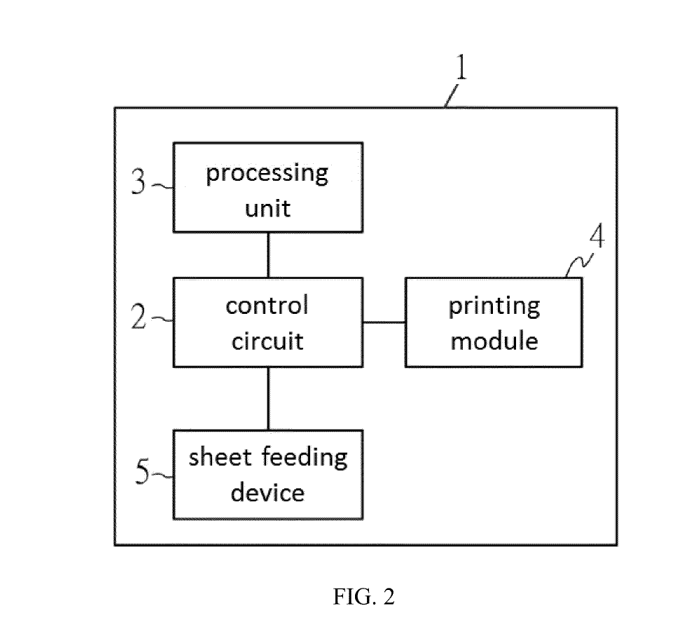

FIG. 2 is a schematic view of the first embodiment of the printing apparatus according to the present invention. As shown in FIG. 2, a printing apparatus 1 comprises a control circuit 2, a processing unit 3, a printing module 4 and a sheet feeding device 5. The processing unit 3 is used to process an initial document. The processing unit 3 identifies an object within the initial document. The control circuit 2 is connected electrically to the processing unit 3, and controls the sheet feeding device 5 to feed a recording medium based on the object identified by the processing unit 3. Preferably, the recording medium comprises a paper, other sheet material or non-sheet material. The printing module 4 is connected electrically to the control circuit 2, and prints data of the object on the fed recording medium. Preferably, the printing apparatus 1 may be a printer with single function, or a multi-function printer with functions of scan, fax and print.

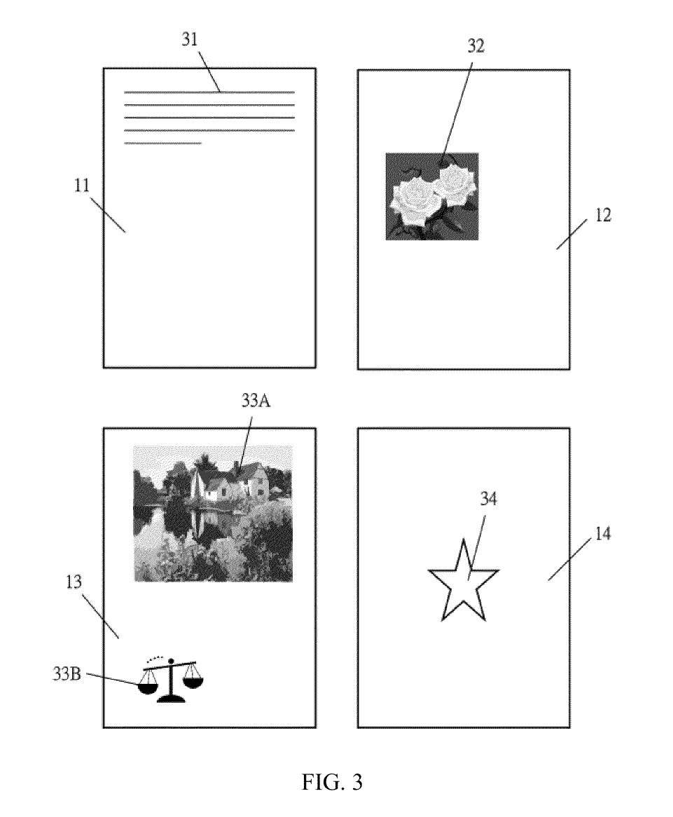

The initial document comprises data, soft copy, or electronic document accessed or received from an apparatus or internal hard disk, for example, an electronic file or PDL (page description language) transmitted to the printing apparatus 1 from a PC or a mobile device via electrical connection; or an electronic file accessed from a removable storage device, such as USB flash drive or portable hard disk device. The initial document may be image data generated by the scanning device accompanied with the printing apparatus 1, and the scanning device scans an original document sheet to output image data. FIG. 3 is a schematic view of the initial documents of the present invention, and displays the initial documents comprising a variety of objects. As shown in FIG. 3, the initial documents 11, 12, 13 and 14 records a lettered object 31, a picture object 32, a colorful object 33A, a monochrome object 33B and a specific shape object 34, respectively.

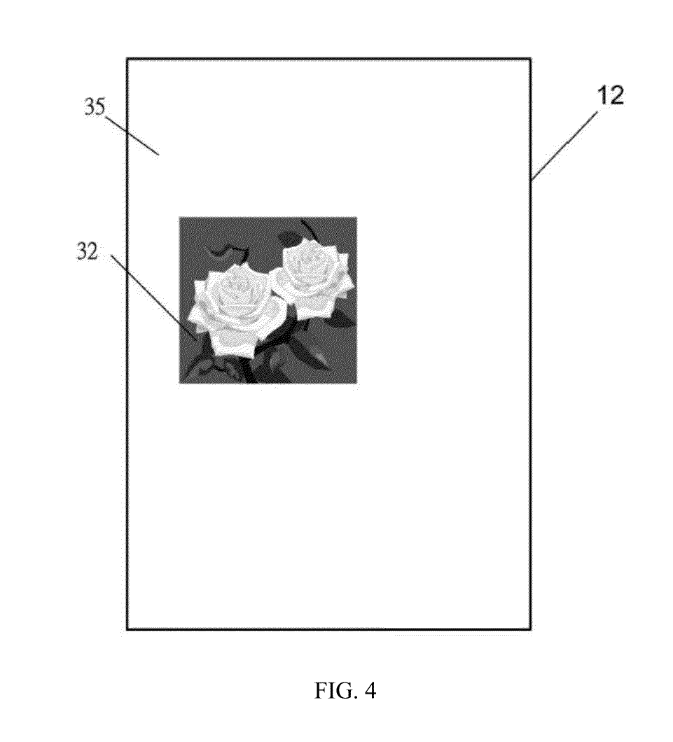

The detail is described according to the initial document 12 below. FIG. 4 displays the schematic view of the initial document 12 having a picture object 32 shown in FIG. 3. As shown in FIG. 4, the initial document 12 is an A3 size of document recording the picture object 32. Please refer to both FIG. 2 and FIG. 4. In the data printing process, the processing unit 3 processes the initial document 12. The processing unit 3 identifies picture object 32 within the initial document 12 by defining the outline of the picture object 32, or defining the boundary between background 35 and the picture object 32 within the initial document 12. The processing unit 3 separates the picture object 32 from the initial document 12. The control circuit 2 controls the sheet feeding device 5 to feed recording medium based on the picture object 32 identified by the processing unit 3. While processing the initial document 12, the processing unit 3 cam further arrange or rotate the picture object 32 so that the processed picture object 32 can be suitably printed on smaller size of recording medium. For example, if the initial document 12 records numerous picture objects 32 at random positions, the processing unit 3 may arrange picture objects 32 in one row or column.

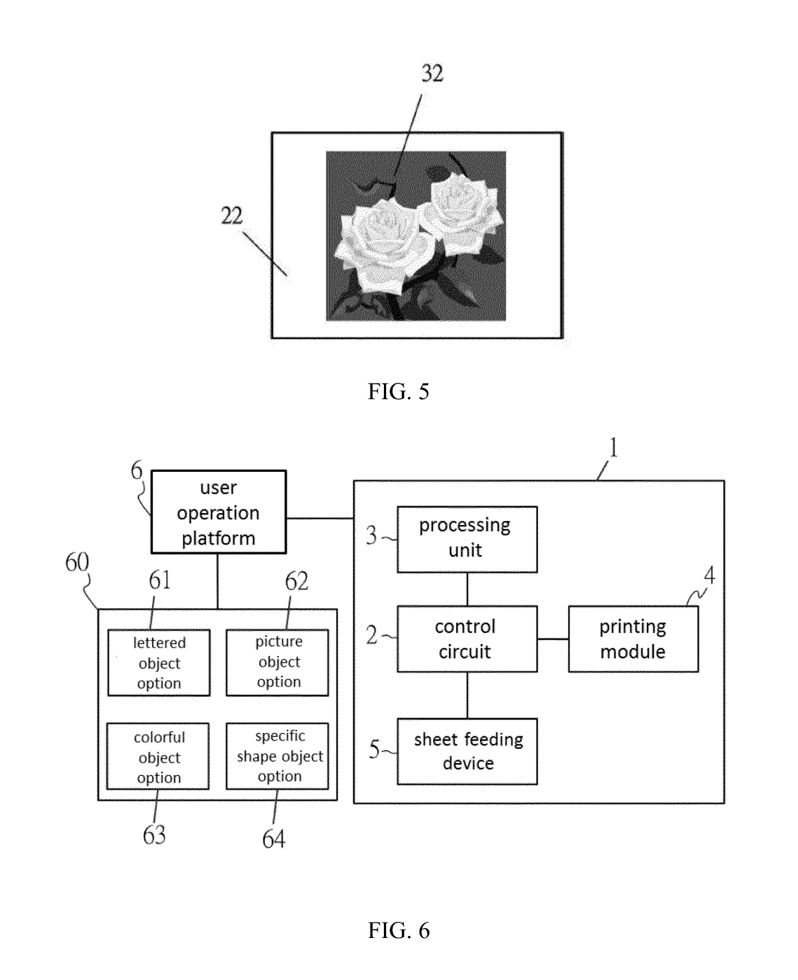

Preferably, the control circuit 2 controls the sheet feeding device 5 to feed recording medium based on the attribute of the object, such as size or color. When the processing unit 3 determines that size of the picture object 32 is smaller than A5 size but larger than A6 size, the control circuit 2 controls the sheet feeding device 5 to feed A5 size of recording medium based on size of the picture object 32. The printing module 4 prints data of the picture object 32 on the fed A5 size of recording medium. FIG. 5 is a schematic view of a document sheet printed by the printing apparatus according to the first embodiment of the present invention. As shown in FIG. 5, compared with A3 size of the initial document 12, the page of the recording medium 22 is just larger than the picture object 32 a little and the useless blank region is reduced effectively. Besides, the control circuit 2 can control the sheet feeding device 5 based on the color of the object. For example, when the color of the picture object 32 is close to light colors, the control circuit 2 can control the sheet feeding device 5 to feed a dark recording medium.

In this embodiment, the picture object 32 is taken as an example for description. However, it also can be replaced by the initial document 11 with the lettered object 31 shown in FIG. 3, the initial document 13 with the colorful object 33A or the monochrome object 33B shown in FIG. 3, or the initial document 14 with the specific shape object 34 shown in FIG. 3. Their printing operation is the same as the picture object 32 described in this embodiment, so the detail description is omitted. Besides, the recording medium fed by the sheet feeding device 5 does not always need to match size of the object completely, but can select the most appropriate recording medium from the backup recording mediums. If providing a variety of recording mediums, the printing apparatus 1 usually has to install several cassettes so the sheet feeding device 5 becomes more complicated with higher cost. It is not profit that the consumables resource is saved while the cost of the printing apparatus becomes higher. The above description is taken as an example, if size of the initial document is A3 size, the object is most appropriate to be printed on A5 size of recording medium. However, there are only A3 and A4 sizes of recording mediums stored in the printing apparatus 1, and then the printing apparatus 1 will print data of object on an A4 size of recording medium without persisting in an A5 size of recording medium.

For another example, the control circuit 2 may control the sheet feeding device 5 to feed an appropriate kind of recording medium based on the content of the object, except the size or the color of the object. For instance, if the content of an object within the initial document comprises tax administration data, the control circuit 2 may control the sheet feeding device 5 to feed carbon sheet or receipt for tax administration, or thin sheet for invoice. Therefore, user does not have to select a kind of recording medium manually, and the printing apparatus 1 of the present invention can judge the most appropriate type of recording medium based on the content of the object. For example, when the content of the object which comprises address, sender or addressee is identified, the information of the object is then printed on an envelope automatically.

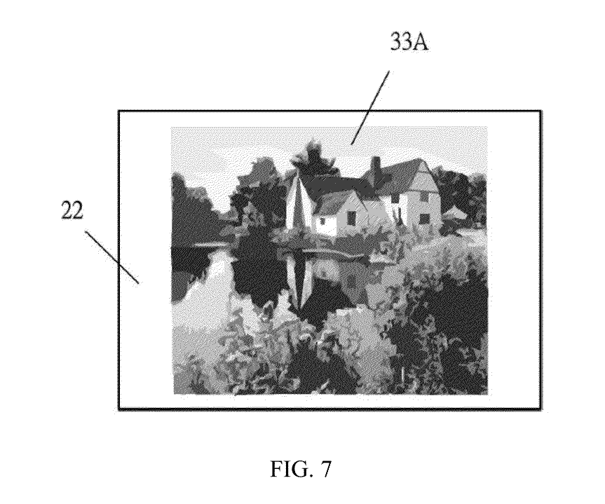

FIG. 6 is a schematic view of the second embodiment of the printing apparatus according to the present invention. In this embodiment, the printing apparatus 1 is further connected electrically to a user operation platform 6 which provides at least one object option to allow user to assign the object to be printed. The user operation platform 6 comprises an operation panel disposed on the body of the printing apparatus 1, and is used to receive user's input instruction. The user operation platform 6 also can comprise a personal computer connected with the printing apparatus 1. The processing unit 3 identifies the corresponding object within the initial document based on the object option selected by user. In this embodiment, the user operation platform 6 is provided with numerous object options 60 including lettered object option 61, picture object option 62, colorful object option 63 or specific shape object option 64, etc. Therefore, the printing apparatus 1 not only can identify the object automatically, but also allows user to input an object type to be printed via the user operation platform 6. And then the printing apparatus 1 identifies corresponding object within the initial document based on the object type selected by user. FIG. 7 is a schematic view of a document sheet of printed by the printing apparatus according to the second embodiment of the present invention. In both FIG. 3 and FIG. 7, the initial document 13 in FIG. 3 is taken as example. When the user selects the colorful object option 63 from object options 60, the processing unit 3 identifies the colorful object 33A within the initial document 13, and the printing module 4 just prints the colorful object 33A on recording medium 22 without the monochrome object 33B. Similarly, if the initial document contains a lettered object and a picture object, the processing unit 3 only identifies the lettered object within the initial document and the printing module 4 only prints the lettered object when user selects the lettered object option 61 from object options 60.

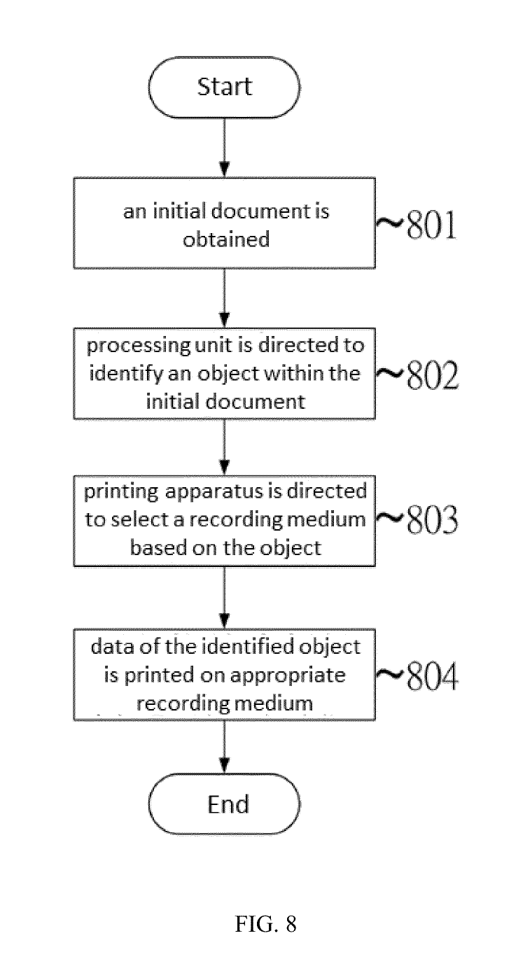

FIG. 8 is a flow of a preferred embodiment of method for printing object data according to the present invention, and each of steps will be illustrated according to this flow. In step 801, an initial document is obtained. In step 802, a processing unit is directed to identify an object within the initial document. Next, in step 803, a printing apparatus is directed to select a recording medium based on the identified object. The step 803 can be implemented by two ways. In the first way, the printing apparatus is directed to select the recording medium based on the attribute of the identified object. In the second way, the printing apparatus is directed to select the recording medium based on the content of the identified object. Furthermore, the step of directing the printing apparatus to select the recording medium based on attribute of the object, comprises a step of directing the printing apparatus to select an appropriate size of recording medium based on the size of the identified object; or selecting an appropriate color of recording medium based on the color of the identified object. Finally, in step 804, the data of the identified object is printed on appropriate recording medium. Except the above steps, at least one object option may be further provided to allow user to assign type of the object to be printed. These object options comprise at least one of options for the lettered object, the picture object, the colorful object and the specific shape object.

Except the above printing apparatus 1, the method for printing object data according to the present invention can also apply to the printing apparatus without the processing unit 3. The initial document is processed and the object within the initial document is identified by a personal computer. Next, the printing apparatus is directed by a printer driver to select an appropriate recording medium, and data of the object is printed on the recording medium finally.

The method for printing object data according to the present invention and the printing apparatus using such method can achieve objectives of simplifying operation procedure for users, saving consumables and shortening printing time upon scheme of identifying object within an initial document and selecting recording medium based on the object.

While this disclosure has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method for printing object, comprising:
directing a processing unit to identify an object within an initial document;
directing a printing apparatus to select a recording medium based on the object; and
directing the printing apparatus to print data of the object on the recording medium.

2. The method of claim 1, wherein the step of directing the printing apparatus to select the recording medium based on the object further comprises a step of:
directing the printing apparatus to select the recording medium based on an attribute of the object.

3. The method of claim 2, wherein the step of directing the printing apparatus to select the recording medium based on the attribute of the object further comprises a step of:
directing the printing apparatus to select an appropriate size of the recording medium based on the size of the object.

4. The method of claim 1, wherein the step of directing the printing apparatus to select the recording medium based on the object further comprises a step of:
directing the printing apparatus to select the recording medium based on the content of the object.

5. The method of claim 1, wherein the step of directing processing unit to identify the object within the initial document further comprises a step of:
directing the processing unit to define the outline of the object.

6. The method of claim 1, wherein the step of directing processing unit to identify the object within the initial document further comprises a step of:
directing the processing unit to define a boundary between a background and the object within the initial document, and separating the object from the initial document.

7. The method of claim 1, further comprising a step of:
directing the processing unit to arrange or to rotate the object.

8. The method of claim 1, further comprising steps of:
providing an object option to allow user to assign the object to be printed; and
identifying the object within the initial document based on the selected object option;
wherein the object option comprises one of options for a lettered object, a picture object, a colorful object and a specific shape object.

9. A printing apparatus, comprising:
a sheet feeding device;
a processing unit, processing an initial document, and identifying an object within the initial document;
a control circuit, connected electrically to the processing unit, and controlling the sheet feeding device to feed a recording medium based on the object identified by the processing unit; and
a printing module, connected electrically to the control circuit, and printing data of the object on the fed recording medium.

10. The printing apparatus of claim 9, wherein the control circuit controls the sheet feeding device to feed the recording medium based on an attribute of the object.

11. The printing apparatus of claim 10, wherein the control circuit controls the sheet feeding device to feed an appropriate size of the recording medium based on the size of the object.

12. The printing apparatus of claim 9, wherein the control circuit controls the sheet feeding device to feed the recording medium based on the content of the object.

13. The printing apparatus of claim 9, further connected electrically to a user operation platform to allow the user assign the object to be printed, wherein the processing unit identifies the object within the initial document based on the selected object option;
wherein the object option comprises of one of options for a lettered object, a picture object, a colorful object and a specific shape object.
